(19) United States
(12) Patent Application Publication
(10) Pub. No.: US 2002/0150732 A1
(43) Pub. Date: Oct. 17, 2002

(54) Image receptor sheet containing vinylpyridine copolymer

(76) Inventors: Manisha Sarkar, Austin, TX (US); Mahfuza B. Ali, Mendota Heights, MN (US); Alan G. Miller, Austin, MN (US)

Correspondence Address: Attention: John A. Fortkort, Office of Intellectual Property Counsel, 3M Innovative Properties Company, P.O. Box 33427, St. Paul, MN, 55133-3427, US

(21) Appl. No.: 09/780,078

(22) Filed: Feb. 9, 2001

(51) Int. Cl. B32B 3/00; B32B 27/14; B05D 5/12

(52) U.S. Cl. 428/195; 427/128

(57) ABSTRACT

An image receiving layer comprising an ink receptive crosslinked polymer comprising the reaction product of a multifunctional aziridine crosslinking agent and a polymer containing protonated pyridine substituents. Image receiving layers may also contain at least one swellable polymer and additives such as particulates, mordants, fillers and the like.

### FIELD OF THE INVENTION

The invention relates generally to image receptor sheets, and in particular to image receptor sheets containing vinylpyridine copolymers.

### BACKGROUND OF THE INVENTION

The presentation of pictorial and textual images requires materials, as image receptors, that retain evidence of the color, tone, resolution and brightness of the original pictorial subject or textual message. Certain characteristics are required of image receptor materials to provide suitable contrast and fidelity of image reproduction. This need applies particularly to receptors used for recording images formed from colored droplets such as those delivered by ink jet printers and copiers. An image recorded as liquid droplets requires a receptor on which the recording liquid dries quickly without running or spreading. High quality image reproduction using ink jet printing techniques requires receptor substrates, typically sheets of paper or opaque or transparent film, that readily absorb ink droplets while preventing droplet diffusion or migration. Ready absorption of ink encourages image drying, while minimizing image migration maintains the sharpness of the appearance of the recorded image.

Advances in ink jet printing technology have yielded ink jet printers requiring less time for complete image generation. Improvements in printer technology translate into the need for improved receptor materials that satisfy a number of important requirements related to increasing speeds of multicolor printers. In addition to the need for image sharpness and rapid absorption of ink droplets, there is a demand for image receptors that satisfy quality standards with respect to brightness, opacity, internal strength, and resistance to picking and scuffing. An effective receptor material also protects an image from water damage that would extract color from an image or distort its appearance by image bleeding due to spreading of an area of colored dye.

Solutions to problems associated with the use of aqueous ink jet inks include the use of water swellable polymers, and hydrophilic additives to improve liquid absorption and drying rate. The use of mordants provides control of liquid droplets, as deposited, to enhance image sharpness and limit droplet migration that appears as image bleeding.

Despite improvements in the performance of ink jet image receptors, a challenge exists to provide sheet materials that allow multiple imaged sheets to be stacked in the output tray of ink jet color printers without evidence of image transfer between sheets in the stack. Such image transfer is also known as image offset or blocking.

Receptor sheet durability is an issue related to the preservation of recorded images which may be damaged by picking and scuffing. Picking and scuffing could occur during stacking of multiple sheets during high speed printing or copying. Therefore, increased durability may allow stacking of imaged sheets with less blocking, in less time. This is becoming important in response to the increasing image generation speed of ink jet printers.

Crosslinking is frequently employed in the polymer arts to increase the toughness and durability of polymers. The benefits of crosslinked polymers may be applied to image receptor layers. In the case of ink jet imaging, coatings for receptor layers typically comprise water soluble polymers which, upon crosslinking, become less water soluble and exhibit reduced tack and increased durability, especially in imaged areas that are saturated with aqueous-based ink. In the case of image receptor layers, such crosslinking has been achieved through the addition of external crosslinking agents, such as multifunctional aziridine compounds, which react with functionalized materials in the receptor layer. For example, the use of multifunctional aziridine compounds to crosslink carboxylate species is described in a number of references, including U.S. Pat. Nos. 3,470,136, U.S. 3,507,837, U.S. 3,817,945, U.S. 3,959,228, U.S. 4,490,505, U.S. 5,208,092 and U.S. 5,389,723.

Unfortunately, the use of external crosslinking agents in coating formulations has a number of inherent disadvantages, one being a shortened pot life. In particular, most externally added crosslinking agents induce crosslinking reactions even under ambient conditions. The progress of such crosslinking is manifest by an increasing viscosity, sometimes accompanied by gelling, of the coating formulation as a function of time, until the viscosity is such that the coating formulation can no longer be used.

There is thus a need in the art for a coating formulation, suitable for use on imaging substrates, that has a longer pot life, but retains the benefits of crosslinking. There is also a need in the art for coating formulations for imaging substrates that provide for low color bleeding, fast drying times and improved durability. These and other needs are met by the present invention, as hereinafter described.

### SUMMARY OF THE INVENTION

In one aspect, the present invention relates to coating formulations, and to image receptor layers containing the same, which comprise one or more copolymers that contain, or which can be treated to contain, polar moieties capable of undergoing inter-molecular or intra-molecular interactions to provide a coating with reduced water solubility. This may be accomplished, for example, through the use of copolymers having protonated pyridine moieties and having other monomers, such as EOA or NVP, which are capable of interacting with the pyridine moieties to form a polymer network through hydrogen bonding or other electrostatic interactions. Image receptor substrates made with such copolymers provide excellent image qualities without any of the infirmities noted with respect to conventional coating materials.

In another aspect, the present invention relates to a method for making an imaging substrate. In accordance with the method, a substrate is coated with a formulation comprising one or more copolymers which contain, or which can be further treated to contain, polar moieties that are capable of undergoing inter-molecular or intra-molecular interactions to provide a coating with reduced water solubility.

In the preferred embodiment, the imaging substrate of the present invention comprises a coated receptor for images formed from droplets of colorants issuing from discharge elements of image reproducing equipment, such as the nozzles of ink jet printers. A coated receptor, according to the present invention, includes an ink receptive layer comprising up to 98% of a copolymer of a protonated polyvinylpyridine. This copolymer gives rise to polymer networks via intra-molecular or inter-molecular interactions between polar moieties present in the copolymer. The ink receptive layers comprising such pyridine-containing copolymers exhibit improved performance with respect to durability, scuff resistance, and image fidelity. They also exhibit water and moisture stability and limit migration that leads to image bleeding. The use of pigmented inks, applied to receptor layers according to the present invention, typically produces images of higher density with less “mud cracking.” Coating compositions, used for ink receptive layers, possess improved stability for extended periods of time (e.g., improved pot life), compared with comparable systems that rely on the use of external crosslinking agents. Receptor layer compositions according to the present invention dry efficiently, after coating, at temperatures that minimize damage to substrate materials including paper and film substrates.

Preparation of a durable receptor layer according to the present invention relies upon the formation of a polymer network that may be accomplished in at least two ways. In one embodiment of the invention, the structure of a pyridine-containing polymer that undergoes inter-molecular or intra-molecular interaction between polar moieties may contain the maximum number of pyridine substituents using a copolymer comprising a high percentage of vinyl pyridine monomer. High incidence of pyridine groups increases the probability of intra-molecular or inter-molecular reactions. Alternatively, a copolymer of vinyl pyridine containing fewer pyridine groups will result in a lower level of these interactions, depending upon the amount of vinyl pyridine constituent in the copolymer. Anticipating that the durability of a receptor layer will increase with increased interaction between the polar moieties, adjustment of proportions of vinyl pyridine to other monomers in a copolymer should allow adjustment of receptor layer durability. Due to the dependence of durability on the concentration of pyridine substituents, effective performance of receptor layers in terms of abrasion resistance and scuff resistance is partially dependent upon the selection of other monomers used to form copolymers with vinylpyridine. A wide variety of copolymers may be used provided they include from about 2% to about 95%, preferably about 15% to about 45% pyridine substituents.

Another approach to varying the interaction between polar moieties in polymers and copolymers produced using vinyl pyridine involves the protonation of either all or only a portion of available pyridine substituents. Fully protonated polymers provide a higher degree of interaction than partially protonated polymers based on the same polymer structure. Durability of receptor layers may be varied, therefore, by changing the amount of vinyl pyridine included in a polymer backbone or adjusting the degree of protonation. The facility for adjusting the durability of interacted polymers also leads to the preparation of self-supporting image receptor layers that may be formed into sheet and film structures without need for a supporting substrate.

Another benefit of protonation is the formation of an internal mordant in receptor layers according to the present invention. The pyridinium groups produced by protonation also provide charge centers that are beneficial for reducing dye diffusion that leads to bleeding. This added advantage reduces or eliminates dependency on known mordant compounds that may be added to receptor layer compositions according to the present invention.

The previous discussion shows the multiple advantages of receptor layers comprising vinyl pyridine copolymers. Incorporation of such copolymers provides variable durability in terms of layer integrity and resistance to rubbing, scuffing and related abrasion. Durability depends on the extent of the intermolecular or intramolecular interaction achieved. The production of pyridinium ions imparts mordant capacity to receptor layers according to the present invention. Pyridine containing copolymers provide the dual function of polar moieties which are capable of undergoing intramolecular or intermolecular interactions, and mordant to improve the performance of ink jet image receptors.

More particularly, the present invention provides an image receiving layer comprising an ink receptive copolymer comprising the intra-molecular or inter-molecular reaction product of a copolymer containing polar moieties, including protonated pyridine substituents. Image receiving layers may also contain at least one swellable polymer selected from the group consisting of polyvinyl alcohol, hydroxypropylmethyl cellulose, polyvinylpyrrolidone, hydroxyethylcellulose, hydroxypropylcellulose, polyacrylamide, polyethylene oxide, gelatins, starches, and copolymers and blends thereof. Additional benefits may be derived by inclusion of particulates, mordants, fillers and the like.

Definitions

Terms used herein have the meaning indicated in the following definitions.

The terms “receptor layer” or “image receiving layer” refer to a composition that is suitably self supporting to absorb droplets of aqueous-based ink without deteriorating.

A “receptor sheet” includes a receptor layer coated on a substrate to provide added support to the receptor layer. A substrate may be in the form of a paper product or an opaque or transparent resin or polymer film.

The term “ink absorption” or “liquid absorption” refers to the affinity of a receptor layer for aqueous-based inks and related colored liquids so as to attract them into the body of the layer and away from the surface, thus promoting surface drying.

“Aqueous-based ink” refers to ink composed of an aqueous carrier and a colorant such as a dye or pigment dispersion. An aqueous carrier may contain water or a mixture of water and a solvent.

The term “water stability” refers to the capacity of a receptor layer to remain intact in contact with water, during water soaking or application of water as a continuous stream.

“A swellable polymer” is an ink or liquid absorbing material that increases in volume during contact with aqueous-based inks thereby increasing its liquid uptake rate and holding capacity.

The term “durability” refers to that property of a receptor layer that protects it from impact, rubbing and scuffing to preserve the integrity of the receptor layer both before and after the deposit of an image of liquid droplets. Receptor layer durability herein accrues from the provision of a polymer network structure within the layer resulting from intermolecular or intramolecular interactions.

“A mordant” is a material that interacts with the dyes contained in inks to decrease or prevent their diffusion through the media. Diffusion of dyes, after imaging, results in the spreading of colors from one area to another, often seen as apparent broadening of fine lines during image storage.

The term “bleeding” refers to previously described diffusion of dyes through the media after imaging. Diffusion adversely affects image appearance due to deterioration in the resolution and sharpness of pictorial elements. Bleeding may be lessened or prevented by the use of mordant compounds.

A “functional material” herein refers to a material included in a receptor layer to enhance or improve properties associated with recording, retaining and displaying of images, particularly ink jet printed images.

The term “optional material” refers to a material included in a receptor layer to improve non-image properties, such as handling and feeding or receptor sheets according to the present invention.

“Image offset or blocking” refers to the indiscriminate transfer of liquid ink by contact with other surfaces and objects when an image of ink droplets remains wet too long on the surface of a receptor layer. The same term may be used to describe transfer, between surfaces, of portions of a receptor layer due to lack of internal cohesion of the layer or lack of adhesion to the substrate of an receptor sheet. Such transfer is detrimental to the stacking of multiple receptor sheets since a wet image or fragile receptor layer will tend to transfer to the backside of the next receptor sheet ejected into the output tray of a high speed ink jet printer.

The term “(meth)acrylate” indicates the use of either an acrylate ester or a methacrylate ester.

“Mud cracking” refers to micro-cracking apparent within imaged areas of receptor layers printed with pigmented inks. Micro-cracking adversely affects image quality.

The terms “pyridine substituent” or “pyridine content” refer to pendent groups included in a polymeric structure and the concentration of such groups in a polymer.

“Protonation” refers to the addition of a hydrogen ion to a pyridine substituent to produce a positively charged pyridinium ion attached to a polymeric structure.

“NVP” means N-vinyl-2-pyrrolidinone.

“MEA” means methoxyethylacrylate.

“EOA” means methoxy polyethylene glycol acrylate.

“VPy” means 4-vinylpyridine.

“Vazo-67” is a trade name for 2,2′-azobis(2-methylbutanenitrile).

Having described improvement in durability and internal mordant capacity the enhancements and benefits provided by receptor layers are described in greater detail herein below with respect to several alternative embodiments of the present invention.

### DETAILED DESCRIPTION OF THE INVENTION

The present invention provides receptor layers for images produced during the operation of computer controlled ink jet printers. After application to selected substrates, preferably in the form of sheet materials such as paper and opaque and transparent films, receptor layers preserve desirable appearance characteristics of sharpness without bleeding for images produced by ink jet printers. These characteristics result from properties of the receptor layers that encourage rapid liquid ink absorption yet limit diffusion of ink droplets within the layer. Rapid liquid absorption draws ink away from the surface of a receptor layer to reduce surface spreading or puddling of liquid inks. Removal of surface liquid from imaged sheets produces printed output that is less susceptible to ink transfer between sheets. This, combined with the interactions in the copolymer, also results in less blocking during stacking of images from high speed printers. During stacking of imaged sheets, sliding contact occurs between individual sheets as they are delivered to a printer's output tray. Sliding contact may cause surface scuffing as imaged sheets rub together. Image offset also occurs during such contact unless receptor layers possess properties that lead to rapid surface drying and durability.

The receptor layers of the present invention are characterized by scuff resistance and increased durability. Resistance to scuffing is possible by the intermolecular or intramolecular interactions of at least one component in the receptor layer compositions according to the present invention. There are few suitable systems for forming polymer networks in receptor layers for ink jet images. The reaction by which such networks are formed must typically occur under relatively mild drying conditions as needed to prevent damage to thermally sensitive receptor layer bearing substrates, particularly photopaper backings and transparent backings such as polyester films. Also, maintenance of receptor performance requires that the reaction by which the network is formed be substantially irreversible. Preferably the reaction occurs at oven temperatures and dwell times that substantially prevent discoloration or damage either to a substrate or to a receptor layer. It will be appreciated that any discoloration of either a receptor layer or a receptor sheet can be detrimental to the appearance of a printed image. Reference to receptor sheet damage may be appreciated considering the types of surface imperfection produced by many polyethylene coated papers that typically blister if heated above 145° C. (290° F.) for longer than 2 minutes.

The compositions of the present invention rely on intramolecular or intermolecular interaction of the component copolymers as effected by the provision of diverse polar moieties within the same comonomer that are capable of interreacting. The interaction is of a type that reduces the water solubility of the copolymer after the liquid medium is removed from the coating composition. This interaction will most commonly be an electrostatic interaction, such as hydrogen bonding, although other forms of intramolecular or intermolecular interactions are also contemplated.

Preferably, the copolymers used in the coating compositions of the present invention contain pyridine substituents which are capable of undergoing protonation through intramolecular or intermolecular processes. This provides improved control of coating and thermal curing of receptor layers according to the present invention. Moreover, the intermolecular or intramolecular reaction of the diverse polar groups on the comonomer or copolymer offers durable receptor layers that in addition possess the properties of a mordant. Also, this system provides water resistant receptor layers retaining images that lose relatively little density when soaked in water. They also show extremely good high humidity bleed performance. Of course, copolymers containing other heterocyclic substituents, such as imidazole, may also be used in a similar manner.

In addition to providing desirable improvement in the durability of ink jet image receptor layers, the copolymers of the present invention yield cationic species associated with the vinylpyridine groups. The presence of cationic sites on interacted polymers in receptor layers according to the present invention contributes to increased mordanting of dyes and less bleeding of recorded images. This benefit is not obtainable with polymers crosslinked via the conventional reaction of multifunctional aziridines and carboxylic acid functionality.

The added benefits of increased durability and mordant capacity of receptor layers containing polyvinylpyridine and related polymers arise from the use of a highly charged cationic polymer before interaction. High levels of cationic species with pyridine-containing systems usually occur under acidic conditions. Similar conditions existing during crosslinking of conventional carboxylic acid functional polymers lead to accelerated crosslinking activity and less stability of receptor layer compositions before coating. This makes even more surprising the fact that the highly protonated copolymers of the present invention, which contain pyridine and other polar groups, remain relatively unreactive in solution.

The receptor layer compositions described previously contain water absorbing, water swelling polymers capable of rapidly drawing liquid into the layer and away from the receptor surface. Polyvinyl alcohol is one of a number of swellable polymers that can be used to rapidly absorb liquid into the receptor surface. Other liquid-swellable materials suitable for this purpose include homopolymers and copolymers such as hydroxypropylmethylcellulose, available as METHOCEL from Dow Chemical Company, Midland, Mich., polyvinylpyrrolidone, hydroxyethylcellulose (available under the tradename NATROSOL from Aqualon Company, Palatine, Ill.), hydroxypropylcellulose (available under the tradename KLUCEL from Hercules Inc., Wilmington, Del.), starches, polyethylene oxide, polyacrylamides, gelatin and the like. The crosslinking reaction of polyvinylpyridine that is effective in the presence of polyvinyl alcohol and similar swellable polymers is also effective with copolymers containing vinylpyridine. This allows further modification of receptor layer properties.

Suitable copolymers for use in the present invention include those containing vinyl pyridine (VPy) from about 2.0% to about 95.0%, preferably about 15% to about 45%, and at least one monomer, such as EOA or NVP, which is capable of reacting with the pyridine moieties when they are protonated. The remaining monomers may be chosen to impart various desirable properties to the copolymer. Thus, for example, the monomers may be chosen to ensure that the glass transition temperature of the copolymer is within a desirable range, that the image receiving layer has the proper affinity for water (so that it will not become tacky in high humidity environments), that the copolymerization reaction will carry to completion, that the image receiving layer adheres well to dyes and to cellulosic substrates, and that the image receiving layer will quickly and irreversibly adsorb dyes so that the dyes will not bleed and the images created may be stacked without blocking.

One particularly desirable comonomer for use with VPy is Ethylene Oxide Accrylate (EOA). When EOA is incorporated into the copolymer, it undergoes intermolecular and intramolecular reactions with protonated pyridine to produce a hydrogel. As a result, when dyes are applied to an image receiving surface containing the copolymer, the dye is rapidly adsorbed into the substrate and feels dry to the touch, even before all of the solvent has evaporated. EOA also helps control curl of the image receiving surface without plasticizing the overall coating, since it is hooked up to the main copolymer backbone. By contrast, low molecular weight plasticizers that are often added to image receiving surfaces to control curl often exhibit a tendency to bloom to the surface, which appears as a scum on both the imaged and unimaged portions of the surface, and may also plasticize the overall coating composition in high humidity/high temperature conditions. EOA also contributes favorably to the gloss of the image. EOA copolymers have been made in accordance with the present invention without any external crosslinkers such as aziridine and have provided coating solutions exhibited prolonged pot lives. Moreover, images made with these compositions exhibited faster drying times, good water fastness, image durability and high color densities without showing any bleed at extreme weather conditions such as high temperatures and humidities.

Other particularly desirable copolymers for use in the present invention include mordanted copolymers having an AGH-TFA group bonded to the main copolymer backbone. Such copolymers mordant the overall receptor coating without plasticizing it. When a low molecular weight homopolymer of pyridine is employed as a mordant in a coating composition, there is a limitation in the amount of pyridine that can be used; in particular, too much pyridine plasticizes the coating and exacerbates bleeding rather than helping it. This effect is not observed with mordanted copolymers containing AGH-TFA groups. These copolymers also form hydrogels through intramolecular and intermolecular reactions with protonated pyridine and other polar groups and exhibited excellent absorbency of inks when imaged in standard ink jet printers.

Yet another particularly desirable comonomer for use in the copolymers of the present invention is Acrylamido Methyl Para-Sulfonic Acid (AMPS). Together with VPy, this monomer can be used to form a highly reactive charged copolymer with negatively charged SO₃⁻ groups and positively charged VPy-H⁺ moieties. Though highly reactive, the copolymer is quite stable in dilute solutions. Copolymers based partially on AMPS have been made in accordance with the present invention which, upon drying in a receptor coating, provided a highly swellable hydrogel matrix with good water insolubilities, fast ink drying characteristics, and excellent image durability at extreme weather condition (e.g., high temperature/humidity). Images created on these receptor coatings retained a high gloss and high color densities.

Another highly desirable comonomer for use in the copolymers of the present invention is sulfoethyl acrylate. This monomer provides many of the same advantages and characteristics as AMPS.

In addition to the monomers noted above, other comonomers that may be used to create copolymers in accordance with the present invention may be selected from the group consisting of (meth)acrylate esters, where the ester groups may be alkyl, hydroxyalkyl, alkoxyalkyl, haloalkyl, poly(ethylene glycol) and the like, as well as acrylamides, N-vinyl-2-pyrrolidone (often referred to simply as “N-vinyl pyrrolidinone”), styrene, substituted styrenes, vinyl ethers and the like. Properties of receptor layers may also be varied by adjusting the amounts of acid added to pyridine containing polymers and copolymers to vary the level of protonation of a polymer. Other materials that are useful in compositions according to the present invention include various pyridine salts including pyridinium chloride, sulfate, acetate, trifluoroacetate and the like.

The previous description indicates the need for receptor layers containing polyvinylpyridine to also include a water swellable polymeric component, for rapid absorption of liquid image droplets. A swellable polymer may also be used in receptor layer compositions comprising copolymers having pyridinium substituents such as those formed by reaction of vinylpyridine with other suitable monomer species and materials that react to form a crosslinked component that contributes durability and scuff resistance to the layer. The polymer component of a receptor layer composition may act as a binder for other materials contained in a receptor layer. Other materials may include functional materials that enhance image characteristics, or optional materials to improve, e.g. handling and feeding of coated sheets for optimum performance with printing and copying equipment.

Functional materials that improve image characteristics of receptor layers include plasticizers, surfactants, particulate materials and mordants. Particulate materials may be added to receptor layer compositions in any way that results in thorough dispersion of particles. Addition of particulate material in a pre-dispersed condition, such as the use of sols or emulsions, offers some useful advantages. Receptor layers according to the present invention may comprise particulates including alumina sols and cationic emulsions, and the like. Surprisingly, particulate materials appear to reduce mud cracking associated with the deposit of pigmented inks on receptor layers.

It is known that particulate materials contribute both liquid absorption and mordant properties to receptor layers for ink jet images. As a mordant, a particulate helps to restrict liquid diffusion in a receptor layer to preserve image sharpness. The liquid absorbing capacity of a particulate aids the speed at which a liquid departs from the surface of a receptor layer. This improves the surface-drying rate of image receptor sheets that thereafter exhibit lower incidence of image offset to facilitate more rapid stacking of imaged sheets, as required by the capabilities of current ink jet printers.

The presence of particulate materials and interacted polymers containing pyridinium functionality provides mordant capacity to receptor layers according to the present invention. A mordant is a material that interacts with dyes, contained in the inks, to decrease or prevent their diffusion through the media. Image bleeding reduces image resolution causing the loss of detail from the pictorial presentation captured by an image receptor layer. To further reduce bleeding, known effective mordant compounds may optionally be added to receptor layers. Mordant compounds are well known to those having skill in the imaging and photographic arts. A variety of mordants exist as additives satisfying the image quality needs of receptor layers according to the present invention.

Optional components to improve handling and sheet feeding characteristics may include additives including plasticizers, surfactants and fillers. Suitable plasticizers for receptor layers according to the present invention include, for example, PYCAL 94 (available from ICI Surfactants, New Castle, Del.) sorbitol xylitol, glycerol, mannitol, pentaerythritol, polyethylene glycols and trimethylol propane. Surfactants may be added to aid the coating of receptor layers. They include preferably nonionic or cationic surfactants. Non-limiting examples include surfactants such as various fluorinated materials, including ZONYL FSO, ZONYL FSO 100, ZONYL FSN, and ZONYL FS-330 (available from DuPont Specialty Chemicals, Memphis, Tenn.), alkylphenol ethoxylates, for example TRITON X-100, and TRITON X45 (available from Union Carbide, Danbury, Conn.), polyoxyethyleneglycol derivatives, for example TWEENS 60, TWEENS 61, TWEENS 65 and TWEENS 80 (available from ICI Americas, Inc., Bridgewater, N.J.), polydimethylsiloxane derivatives, such as SILWET L-7600, SILWET L-7605, and SILWET L-7607 (available from OSi Group, Tarrytown, N.Y.), and acetylenic derivatives, for example SURFYNOL 465 and SURFYNOL 486 (available from Air Products and Chemicals, Inc., Orlando, Fla.).

Filler additives may include a variety of types of powder such as silica, alumina, clays, starches, polyolefin powder, polystyrene powders and those having a specific particle shape including spherical particles available in the form of polymeric microspheres and bead polymers such as polymethylmethacrylate (PMMA) beads.

Coatings of receptor layer compositions may be applied by any of a number of methods for applying fluid layers of selected thickness to transparent and opaque substrates. Suitable methods include knife coating, wire bar coating, gravure coating, and extrusion coating.

Receptor layers according to the present invention may be self-supporting. The capability of such layers to retain image fidelity within a single layer, even during soaking with water, demonstrates that they may be used independent of other supports. Preferably, however, a substrate provides support to a coated and thermally cured receptor layer to obtain the benefits to image quality provided by suitable substrates.

For this purpose, suitable substrate materials include paper structures including filled papers developed particularly for quality photographic print presentation. Substrate materials also include opaque and transparent film backings such as cellulose triacetate or cellulose diacetate, polyethylene naphthalate, polystyrene, and polyesters, especially polyethylene terephthalate. Preferred substrates have a caliper between about 50 microns to about 200 microns and develop a strong bond to receptor layers according to the present invention.

To promote adhesion between a substrate and a receptor layer it may be necessary to prime the surface of the substrate using one or more primers applied in single or multiple layers. Coated primers preferably have a thickness less than 2.0 microns. Examples of priming materials include halogenated phenols dissolved in organic solvents, polyvinylidene chloride and gelatin subbing agents. As an alternative, priming of substrate materials may be accomplished using physical priming methods including surface treatment by corona and plasma discharge.

The use of receptor layers according to the present invention primarily addresses the needs of imaging processes associated with ink jet printers and copiers. Receptor sheets produced for this purpose may also find use in other types of imaging processes. Among these imaging processes there may be included electrophotographic methods and related methods based upon image formation using a plurality of image elements such as toner powder particles and wax-containing fluid droplets.

Receptor layers and receptor sheets according to the present invention will be described, as follows, in terms of examples and performance characteristics. Such examples are provided for the purpose of illustration without limiting the scope of the invention.

### EXAMPLE 1

This example demonstrates the synthesis of P(MEA(20%)/EOA(40%)/NVP(10%)VPy-TFA)(30%).

A reaction flask was fitted with a mechanical stirrer, condenser, thermometer and a dropping funnel. The flask was charged with 100.0 parts of distilled water, 190 parts of ethanol, 20 parts of MEA (MethoxyEthyl Acrylate), 40 parts of EOA (Ethylene Oxide Acrylate), 10 parts of VPy (N-Vinyl Pyrrolidinone), and 30 parts of VPy (Vinyl Pyridine). The reaction mixture was stirred at medium speed and purged with nitrogen throughout the reaction. The flask with the mixture was heated to 65° C. and then a solution of 1 part of Vazo-67 in 10 parts of ethanol was added. The reaction was heated for 17 hours at 65° C. The reaction was monitored by percent solids analysis. At this point, another 3.3 parts of Vazo-67 was added while the heating was continued following this cycle until the reaction was 99.9% converted to the desired product.

After completion of the reaction the product was cooled down to room temperature and 23.4 parts of trifluoroacetic acid was added through a dropping funnel very slowly with constant stirring. After all the trifluoroacetic acid was added the reaction was stirred further for additional 30 minutes. The polymer in the flask was diluted with 192 parts of ethanol to make a 20% solid solution of the copolymer. The product was drained in a glass jar.

### EXAMPLE 2

This example illustrates the production of an image receptor layer on a cellulosic substrate in accordance with the present invention.

Into a four ounce jar was placed 37 grams of a 7% solution in water of hydroxy propyl methyl cellulose. To this was added 3.1 grams of colloidal alumina (12% in water), and the mixture was stirred well to disperse uniformly. About 7 grams of a 20% solution of the copolymer described in EXAMPLE 1 was added to the jar followed by 2.3 grams of 22% water solution of p(VPy-TFA) mordant, and the solution was mixed well. Finally, 0.5 grams of Xama-2 was added as a 5% solution in water. The resulting solution was thoroughly mixed and then allowed to stand to remove any entrapped air. The solution was then coated with a knife coater onto an 8 mils thick resin coated paper. The coated paper was then dried at 260° F. for exactly 2 minutes in order to get a dry coating thickness of about 1.2 grams/sq. ft. The finished product was very glossy.

### EXAMPLE 3

This example illustrates the imaging results achieved with the image receptor layers made in accordance with the present invention.

The coated paper from EXAMPLE 2 was cut into 8.5″×11″ size and imaged in various photo quality inkjet printers, including HP 970C, Epson 800, Epson 870, and Epson 1270 ink jet printers. The images had excellent overall quality, high gloss, good color densities, and fast drying times. When tested with water drips on the imaged areas, the images demonstrated water fastness as indicated by no color bleed. After the imaged sample was aged for 5 days in 95 F/80% R.H. humidity, it showed no indications of image distortion or bleed of the dyes.

### EXAMPLE 4

This example demonstrates the synthesis of p(MEA(20%)/EOA(40%)/NVP(l 0%)VPy(30%)).

A reaction flask was fitted with a condenser, a mechanical stirrer, a nitrogen inlet/outlet and a thermometer. The flask was charged with 2000 parts of distilled water, 3700 parts of ethanol, 400 parts of MEA, 800 parts of EOA, 200 parts of NVP and 600 parts of VPy. The mixture was purged with nitrogen throughout the entire reaction cycle. The flask was heated to 65° C. and then a solution of 20 parts of VAZO-67 in 300 parts of ethanol was added to the flask. The reaction was continued in the flask for another 17 hours, while the temperature of the flask was maintained at 65° C. Completion of the reaction was monitored by percent solids of the product in the reaction flask. If the percent solid did not indicate 99.9% completion of the reaction, then another 3.3 parts of VAZO-67 was charged to the reaction vessel and the mixture was allowed to heat for another 8 hours. This process continued until a 99.9% conversion was measured.

### EXAMPLE 5

This example demonstrates the synthesis of aminoguanidine hydrazine-trifluoroacetate (AGH-TFA).

A reaction flask was fitted with a condenser, mechanical stirrer, dropping funnel and a thermometer. To the flask was added 1058.9 parts of distilled water. Then, 325.7 parts of trifluoroacetic acid was added to the flask very slowly through the dropping funnel, followed by 388.57 parts of aminoguanidine bicarbonate(AGBC) which was also added slowly. An endothermic reaction occurred, as indicated by the drop in temperature to 9° C. After all the AGBC was added, the reaction was heated to 40° C. for 30 minutes. Next, 262.8 parts of chloroacetone was added to the flask and the reaction mixture was heated to 40° C. for another 30 minutes. Finally, the reaction mixture was cooled down to room temperature, resulting in the precipitation of a solid product which was dissolved by adding 807 parts of ethanol.

### EXAMPLE 6

This example demonstrates the synthesis of p(MEA(20%)/EOA(40%)/NVP(10%)VPy(30%)-AGH-TFA).

A reaction flask fitted with a condenser, a mechanical stirrer, a thermometer and a dropping funnel was charged with the product from Example 4. From the dropping funnel, the reaction solution from Example 5 was added slowly to the flask with stirring. After the completion of the addition, the reaction mixture was heated at 50° C. for 1 hour. The reaction was monitored by percent solids, and cooled to room temperature. The product copolymer was drained in a container as a 20% solution in water for use in Example 7.

### EXAMPLE 7

This EXAMPLE illustrates the production of an imaging substrate using the copolymers of the present invention.

Into a four ounce jar was placed 37.8 grams of a 7% solution in water of hydroxypropylmethyl cellulose. To this was added 3.1 grams of colloidal alumina (12% in water) which was stirred to disperse uniformly. To this was added 8.8 grams of the copolymer described in Example 6. To this was added 1.0 grams of p(VPy-AGH-TFA) as a mordant. The solution was stirred well and finally 0.5 grams of a 5% solution in water of Xama-2 was added. The whole mixture was stirred well in the same manner as described in Example 2 and then coated in the same manner as described in Example 2.

The finished photo product was imaged and tested in several printers, including an HP970C, an Epson 800, an Epson 870 and an Epson 1270. Excellent image qualities with high gloss, high color densities and sharp image qualities were achieved. Water fastness was also achieved by water drip tests on the imaged areas. Five days aging of the imaged sample at 95 F/80% R.H. conditions indicated no image distortion as indicated by no color bleed of the dyes.

### EXAMPLES 8-14 AND COMPARATIVE EXAMPLE 1

These examples illustrate the manufacture of various copolymer compositions in accordance with the present invention.

Using the general methodology of EXAMPLE 4, a number of copolymer compositions were made using the % by weight of monomers listed in TABLE 1. The methodology used to make EXAMPLE 9 was varied from the general methodology of EXAMPLE 7 in that, because it has AGH-TFA attached to the PVPy, it did not require any p(VPy-AGH-TFA) as a mordant. All other components were the same. It is to be noted that, of these examples, only EXAMPLE C1 lacks polar moieties that are capable of undergoing an intramolecular or intermolecular interaction.

TABLE 1
Compositions of Receptor Layers

| EXAMPLE | 8 | 9 | 10 | 11 | 12 | 13 | 14 | C1 |
|---|---|---|---|---|---|---|---|---|
| MEA | 20 | 20 | — | — | — | — | — | — |
| EOA | 40 | 40 | 30 | — | 20 | 40 | 40 | 30 |
| NVP | 10 | 10 | 20 | 20 | — | 10 | 10 | 20 |
| VPy-TFA | 30 | — | — | — | — | — | — | — |
| VPy-AGH- | — | 30 | — | — | — | — | — | — |
| TFA | | | | | | | | |
| DMAEMA | — | — | — | — | — | — | — | 30 |
| HPA | — | — | — | 30 | — | — | — | — |
| n-BuMA | — | — | — | — | — | 20 | — | — |
| n-BuA | — | — | — | — | — | — | 20 | — |
| EA | — | — | 20 | 20 | 20 | — | — | 20 |
| VPy | — | — | 30 | 30 | 30 | 30 | 30 | — |
| AMPS | — | — | — | — | 30 | — | — | — |

### EXAMPLES 15-21 AND COMPARATIVE EXAMPLE 2

These examples illustrate the use of the copolymers of EXAMPLES 8-14 in imaging substrates.

In EXAMPLES 15-21 and C2, each of the copolymers of EXAMPLES 8-14 and Cl, respectively, were incorporated into imaging substrates following the general methodology of EXAMPLE 7. The substrates were then subjected to imaging tests using HP 970C, Epson 800, Epson 870 and Epson 1270 inkjet printers. Upon imaging, all samples, except those of EXAMPLE C2, produced colorful images that felt dry to the touch within a minute after imaging, and exhibited high gloss and good image sharpness.

The samples were also tested at high humidity and temperature at 95° F. and 80% relative humidity for 5 days to see line widening indicative of bleed. EXAMPLE C2 did not show very good bleed control. Bleed was measured by monitoring the width of red line going on yellow block, blue line going on red block and red line going on blue block, after aging the samples at 95° F./80% R.H. All samples, except those of EXAMPLE C2, showed line widths within the range of 0.6 to 1.0 mm(millimeters). The sample of

### EXAMPLE C2 showed a line width of around 2.8-3.0 mm.

These examples illustrate that the copolymers of the present invention, which contain polar moieties that are capable of undergoing intramolecular or intermolecular interactions, can be used to form imaging substrates that exhibit excellent drying and bleed properties, even in the absence of an external crosslinking agent. By contrast, the material of EXAMPLE C2, which lacked polar moieties that are capable of undergoing intramolecular or intermolecular interactions, did not absorb dyes quickly, and had poor bleeding characteristics.

### EXAMPLES 22-23 AND COMPARATIVE EXAMPLE 3

These examples illustrate the durability and mordanting properties of imaging substrates produced in accordance with the present invention.

In EXAMPLES 22-23 AND C3, samples of the imaging substrates from EXAMPLES 10-11 and C2, respectively, were subjected to a wet rub-on color test and water drip test. In the wet rub-on test, which is a test of image durability, the imaging substrate was imaged in discrete areas with each of the primary colors and a series of combination colors. The images were then allowed to dry for about 10 minutes. After the images had dried, five drops of water were applied to the surface of each substrate and, 10 seconds after the water was applied, the substrates were rubbed in a back-and-forth motion 8 times. The samples were then rated on a scale of 1 to 5, with 5 being the best (little or no smearing of the image) and 1 being the worst (excessive smearing of the image). The results are set forth in TABLE 2.

In the water drip test, which is a test of the mordanting capabilities of the image receptor layer, each of the imaging substrates was held at a 45° angle, and 5 drops of water were applied to each of the discrete color areas. The samples were then rated on a scale of 1 to 5 according to the amount of color leached out by the water, with 5 being the best (little or no leaching) and 1 being the worst (excessive leaching). The results are set forth in TABLE 2.

TABLE 2

| Example | Wet Rub-On Colors | Water drip |
|---|---|---|
| 22 | 4 | 5 |
| 23 | 2 | 4 |
| C3 | 1 | 1 |

The results shown in TABLE 2 demonstrate that imaging substrates can be produced in accordance with the present invention which have excellent image durability and mordanting properties. In particular, EXAMPLE 22 showed both excellent durability and mordanting of the dyes. EXAMPLE 23 exhibited very good mordanting of the dyes, although durability was reduced as compared to EXAMPLE 22, probably because of the removal of EOA. EXAMPLE C3, which lacks a copolymer having polar moieties that are capable of undergoing intermolecular or intramolecular interactions, demonstrated poor durability and mordanting capabilities.

The above description of the invention is merely illustrative, and is not intended to be limiting. Accordingly, the scope of the present invention should be construed solely by reference to the appended claims.

What is claimed is:

1. A composition for forming an image receiving surface on a substrate, comprising:
a liquid medium; and
a copolymer disposed in the liquid medium, said copolymer comprising a first monomeric unit having a first polar moiety and a second monomeric unit having a second polar moiety;
wherein the second polar moiety is capable of interacting with the first polar moiety upon removal of the liquid medium.

2. The composition of claim 1, wherein the first and second polar moieties interact to form a hydrogel upon removal of the liquid medium.

3. The composition of claim 1, wherein the first and second polar moieties interact to form a polymer network upon removal of the liquid medium.

4. The composition of claim 1, wherein the composition is devoid of an external crosslinking agent.

5. The composition of claim 1, wherein the first monomeric unit is vinylimidazole.

6. The composition of claim 1, wherein the first polar moiety is a pyridine ring.

7. The composition of claim 6, wherein the pyridine ring is protonated.

8. The composition of claim 6, wherein the second polar moiety is a hydrogen donor.

9. The composition of claim 1, wherein the second polar moiety has an acidic hydrogen associated with it.

10. The composition of claim 8, wherein the first polar moiety is a hydrogen acceptor.

11. The composition of claim 8, wherein the first polar moiety contains a quaternary nitrogen.

12. The composition of claim 8, wherein the first polar moiety contains a quaternary nitrogen upon removal of the liquid medium.

13. The composition of claim 1, wherein the second polar moiety is selected from the group consisting of —SO₃H and —SO₃⁻.

14. The composition of claim 1, wherein the second monomeric unit is AMPS.

15. The composition of claim 1, wherein the second monomeric unit is SEM.

16. The composition of claim 1, wherein the first monomeric unit is VPy.

17. The composition of claim 1, wherein the first monomeric unit is VPy-TFA.

18. The composition of claim 1, wherein the first monomeric unit is VPy-AGH-TFA.

19. The composition of claim 1, wherein the copolymer comprises EOA.

20. The composition of claim 1, wherein the copolymer comprises monomeric units selected from the group consisting of MEA, BOA, EA, NVP and VPy.

21. The composition of claim 1, wherein the copolymer comprises MEA-EOA-NVP-VPy-TFA.

22. The composition of claim 1, wherein the composition further comprises a protic acid.

23. The composition of claim 15, wherein the protic acid is a carboxylic acid.

24. The composition of claim 1, in combination with a cellulosic substrate.

25. The composition of claim 1, wherein the copolymer contains about 5 to about 40% by weight, based on the total weight of the copolymer, of MEA.

26. The composition of claim 1, wherein the copolymer contains about 10 to about 30% by weight, based on the total weight of the copolymer, of MEA.

27. The composition of claim 1, wherein the copolymer contains about 15 to about 25% by weight, based on the total weight of the copolymer, of MEA.

28. The composition of claim 1, wherein the copolymer contains about 20 to about 60% by weight, based on the total weight of the copolymer, of EOA.

29. The composition of claim 1, wherein the copolymer contains about 30 to about 50% by weight, based on the total weight of the copolymer, of EOA.

30. The composition of claim 1, wherein the copolymer contains about 35 to about 45% by weight, based on the total weight of the copolymer, of EOA.

31. The composition of claim 1, wherein the copolymer contains about 5 to about 15% by weight, based on the total weight of the copolymer, of NVP.

32. The composition of claim 1, wherein the copolymer contains about 20 to about 40% by weight, based on the total weight of the copolymer, of VPy-TFA.

33. The composition of claim 1, wherein the copolymer contains about 25 to about 35% by weight, based on the total weight of the copolymer, of VPy-TFA.

34. The composition of claim 1, wherein the copolymer contains about 20 to about 40% by weight, based on the total weight of the copolymer, of VPy-AGH-TFA.

35. The composition of claim 1, wherein the copolymer contains about 25 to about 35% by weight, based on the total weight of the copolymer, of VPy-AGH-TFA.

36. The composition of claim 1, wherein the copolymer contains about 5 to about 40% by weight, based on the total weight of the copolymer, of MEA, about 20 to about 60% by weight, based on the total weight of the copolymer, of EOA, about 5 to about 15% by weight, based on the total weight of the copolymer, of NVP, 0 to about 40% by weight, based on the total weight of the copolymer, of VPy-TFA, and 0 to about 40% by weight, based on the total weight of the copolymer, of VPy-AGH-TFA.

37. The composition of claim 36, wherein the copolymer contains about 15 to about 25% by weight, based on the total weight of the copolymer, of MEA, about 30 to about 50% by weight, based on the total weight of the copolymer, of EOA, and about 5 to about 15% by weight, based on the total weight of the copolymer, of NVP.

38. A composition for forming an image receiving surface on a substrate, comprising:
a liquid medium; and
a copolymer disposed in the liquid medium, said copolymer comprising vinylpyridine and a second monomeric unit that interacts with vinylpyridine upon removal of the liquid medium to form a hydrogel.

39. A method for producing an image receptor layer, comprising the steps of:
providing a coating composition comprising (a) a liquid medium, and (b) a copolymer comprising a first monomeric unit having a pyridine ring and a second monomeric unit having at least one functional group that is capable of interacting with the pyridine ring of the first monomer upon removal of the liquid medium;
depositing the coating composition onto a substrate; and
removing the liquid medium.

40. The method of claim 39, wherein the pyridine ring is protonated.

41. The method of claim 39, wherein the at least one functional group on the second monomeric unit has an acidic hydrogen.

42. An imaging material, comprising:
a substrate; and
an image receptor layer disposed on said substrate, said image receptor layer comprising a copolymer having a first monomeric unit with a first polar moiety and a second monomeric unit with a second polar moiety;
wherein said first and second polar moieties have interacted to form a polymer network.

43. The imaging material of claim 42, wherein said first monomeric unit is vinylpyridine.

44. The imaging material of claim 42, wherein the image receptor layer is devoid of an external crosslinking agent.

45. The imaging material of claim 42, wherein the substrate is a cellulosic substrate.
